(19) United States
(12) Patent Application Publication
(10) Pub. No.: US 2004/0042882 A1
(43) Pub. Date: Mar. 4, 2004

(54) Hidden hook vehicle restraint with tab

(75) Inventor: Eric J. Breen, Greendale, WI (US)

Correspondence Address: MICHAEL BEST & FRIEDRICH, LLP, 100 E WISCONSIN AVENUE, MILWAUKEE, WI, 53202, US

(73) Assignee: Kelley Company, Inc., Milwaukee, WI

(21) Appl. No.: 10/234,428

(22) Filed: Sep. 4, 2002

(51) Int. Cl. B65G 67/00

(52) U.S. Cl. 414/401

(57) ABSTRACT

A vehicle restraint including a hook member adapted to be coupled to the loading dock. The hook member is mounted for movement toward and away from the dock face and further is mounted for movement up and down relative to the dock face. The hook member is arranged such that it will secure three sides of an ICC bar of a vehicle parked at the loading dock. In one embodiment, the hook member includes a longitudinal portion, a restraining portion, and a tab. The longitudinal portion is adapted to engage a lower portion of the ICC bar, the restraining portion is adapted to engage a front portion of the ICC bar, and the tab is adapted to engage an upper portion of the ICC bar. The above-described restraint can be utilized to perform a method of securing a vehicle having an ICC bar to a loading dock having a dock face. The method comprises positioning the vehicle at the loading dock, moving the hook member upward into alignment with the ICC bar (e.g., using the vertical actuator), and moving the hook member toward the dock face (e.g., using the longitudinal actuator) such that the hook member secures at least three sides of the ICC bar to thereby inhibit removal of the hook member from the ICC bar. In another aspect of the invention, the engagement between the hook member and the ICC bar is monitored to insure that proper engagement in maintained. This insures that the hook member maintains securement of at least three sides of the ICC bar to thereby inhibit removal of the hook member from the ICC bar. In the event that the desired engagement is not maintained, the hook member can be moved toward the ICC bar.

### FIELD OF THE INVENTION

The invention relates to vehicle restraints and, more particularly, to hidden hook vehicle restraints.

### BACKGROUND OF THE INVENTION

Some loading docks are equipped with a vehicle restraint that secures a vehicle (e.g., a truck or trailer) adjacent to the loading dock during loading and unloading operations. The vehicle restraint prevents the vehicle from moving away from the loading dock during loading and unloading operations.

One known type of vehicle restraint includes a hook that is generally located within a pit or depression of the loading dock beneath a ramp of a dock leveler. The hook includes a generally longitudinally extending portion and a restraining portion that is substantially perpendicular to the longitudinal portion. Once a vehicle is parked adjacent to the loading dock, the hook is pivoted downwardly from a stored position to a lowered and retracted position. The hook is then extended past the forward face of the loading dock to a lowered and extended position. The hook is then pivoted upwardly to a raised and extended position where the longitudinal portion contacts the lower portion of an ICC bar of the vehicle. After contact, the hook is retracted to a restrained position where the restraining portion contacts the forward portion of the ICC bar such that the presence of a gap between the ICC bar and the restraining portion is avoided.

The hook is typically extended and retracted by a first hydraulic cylinder and is raised and lowered by a second hydraulic cylinder. The second hydraulic cylinder includes a spring that is located on the stem side of the piston within the cylinder. The spring biases the hook toward the raised position and allows the hook to float with the vehicle during loading and unloading operations.

The above-described vehicle restraints are disadvantageous because they can be manipulated out of contact with the ICC bar, thereby allowing the vehicle to be stolen from the loading dock. The hooks of the prior art vehicle restraints do not include structure that prevents the hook from being forced downward (e.g., by a pry bar). Because the restraining portion is substantially parallel with the forward face of the ICC bar, sufficient downward pressure applied to the longitudinal portion can cause the entire hook to move downward and out of contact with the ICC bar. The hook is allowed to move downwardly because of the spring within the second cylinder biasing the hook toward the raised position.

### SUMMARY OF THE INVENTION

The present invention is directed to a vehicle restraint for restraining a vehicle at a loading dock. In one embodiment, the vehicle restraint includes a hook member adapted to be coupled to the loading dock. The hook member is mounted for movement toward and away from the dock face and further is mounted for movement up and down relative to the dock face. The hook member is arranged such that it will secure three sides of an ICC bar of a vehicle parked at the loading dock.

In one embodiment, the hook member includes a longitudinal portion, a restraining portion, and a tab. The longitudinal portion is adapted to engage a lower portion of the ICC bar, the restraining portion is adapted to engage a front portion of the ICC bar, and the tab is adapted to engage an upper portion of the ICC bar.

In order to provide the above-referenced movement toward and away from the dock face, the restraint can be provided with a longitudinal actuator, such as a hydraulic cylinder. In order to provide the above-referenced movement up and down movement relative to the dock face, the restraint can be provided with a vertical actuator, such as a hydraulic cylinder. To provide both movements, the longitudinal actuator can be pivotally mounted, and the vertical actuator can be designed to pivot the longitudinal actuator.

The above-described restraint can be utilized to perform a method of securing a vehicle having an ICC bar to a loading dock having a dock face, in accordance with the present invention. The method comprises positioning the vehicle at the loading dock, moving the hook member upward into alignment with the ICC bar (e.g., using the vertical actuator), and moving the hook member toward the dock face (e.g., using the longitudinal actuator) such that the hook member secures at least three sides of the ICC bar to thereby inhibit removal of the hook member from the ICC bar. Prior to moving the hook member into alignment with the ICC bar, it is preferred to move the hook member outward away from the dock face (e.g., by extending the hook member from a pit in the dock face). In addition, when moving the hook member upward, the hook member can move along a curved path (e.g., when the hook member is pivotally mounted).

In another aspect of the invention, the engagement between the hook member and the ICC bar is monitored to insure that proper engagement in maintained. This insures that the hook member maintains securement of at least three sides of the ICC bar to thereby inhibit removal of the hook member from the ICC bar. In the event that the desired engagement is not maintained, the hook member can be moved toward the ICC bar. For example, when a longitudinal actuator is being utilized, the longitudinal actuator can be actuated to move the hook member into engagement with the ICC bar. If the longitudinal actuator is a hydraulic cylinder, then the pressure of the hydraulic fluid can be monitored to insure proper engagement of the hook member with the ICC bar.

Other features and advantages of the invention will become apparent to those skilled in the art upon review of the following detailed description, claims, and drawings.

### BRIEF DESCRIPTION OF THE DRAWINGS

FIG. 1 is a perspective view of a loading dock partially cut away to illustrate a vehicle restraint device embodying the present invention.

FIG. 2 is a longitudinal section view of the vehicle restraint device shown in FIG. 1, illustrating the vehicle restraint in a stored position.

FIG. 3 is a view similar to FIG. 2, illustrating the vehicle restraint in a lowered and extended position.

FIG. 4 is a view similar to FIG. 2, illustrating the vehicle restraint in a raised and extended position.

FIG. 5 is a view similar to FIG. 2, illustrating the vehicle restraint in a restrained position.

Before one embodiment of the invention is explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items. The use of “consisting of” and variations thereof herein is meant to encompass only the items listed thereafter. The use of letters to identify elements of a method or process is simply for identification and is not meant to indicate that the elements should be performed in a particular order.

### DETAILED DESCRIPTION

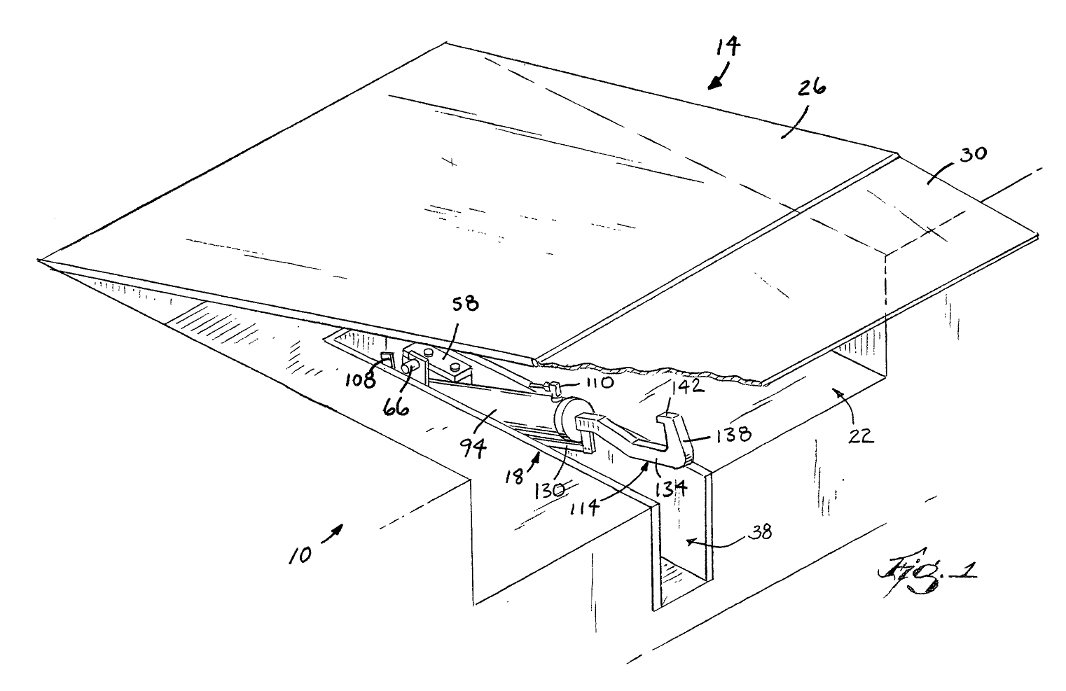

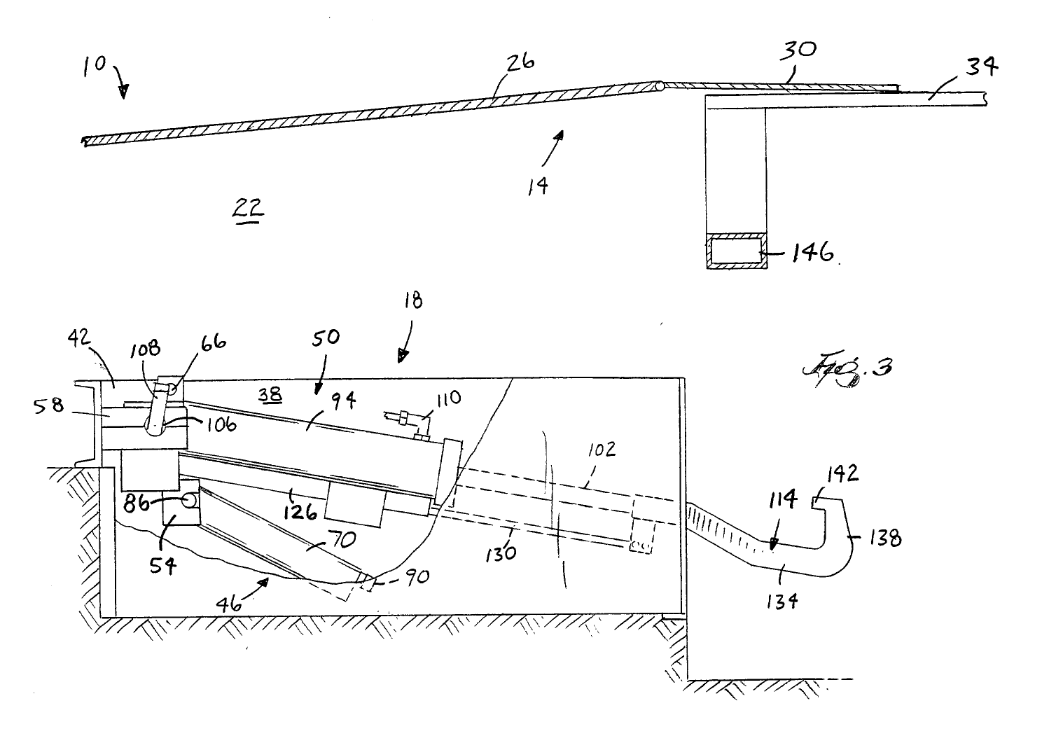

FIG. 1 illustrates a loading dock 10 that includes a dock leveler 14 and a vehicle restraint 18. The dock leveler 14 is partially positioned in a pit or depression 22 in the loading dock 10. The dock leveler 14 includes a ramp 26 pivotally mounted at one end to the loading dock 10 and a lip 30 pivotally connected to the other end of the ramp 26. When a vehicle 34 is positioned adjacent the loading dock 10, the ramp 26 is raised, the lip 30 is extended, and the ramp 26 is lowered with the lip 30 in the extended position to contact the bed of the vehicle 34 (FIG. 3). The dock leveler 14 thereby bridges the gap between the loading dock 10 and the vehicle 34 to facilitate loading and unloading of the vehicle 34. The dock leveler 14 can be actuated by conventional methods known by those skilled in the art, such as by hydraulics, pneumatics, inflatable members, or mechanical springs.

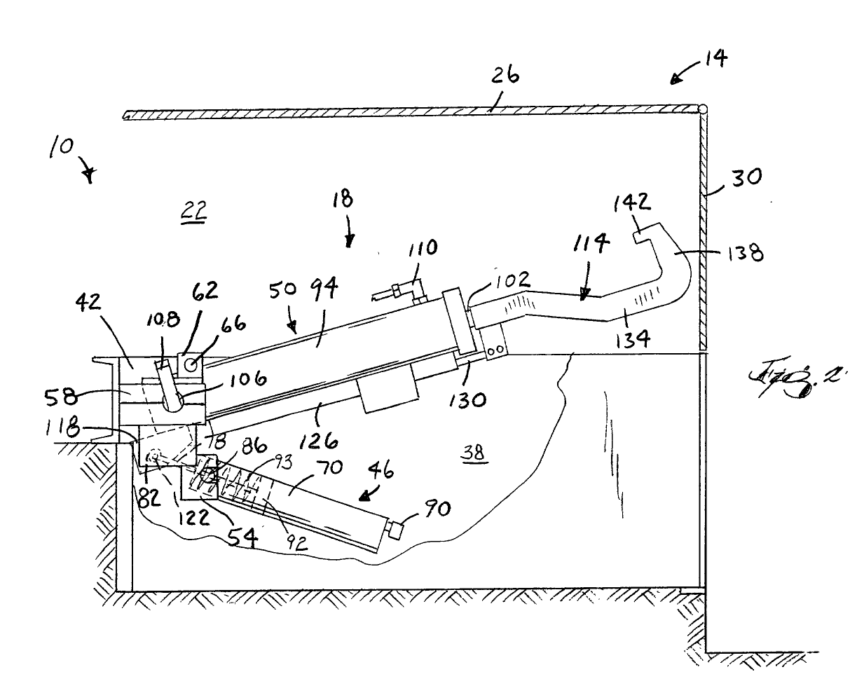

With reference to FIG. 2, the vehicle restraint 18 is mounted beneath the dock leveler 14 in a second pit or depression 38 in the loading dock 10. The vehicle restraint 18 includes a frame 42, a hold-down cylinder assembly 46, a hook cylinder assembly 50, and a hydraulic power unit (not shown). The vehicle restraint 18 secures the vehicle 34 adjacent to the loading dock 10 such that the vehicle 34 is inhibited from moving away from the loading dock 10 during loading and unloading of the vehicle 34.

The frame 42 includes a first set of cylinder keepers 54 for coupling the hold-down cylinder assembly 46 to the frame 42, a second set of cylinder keepers 58 for coupling the hook cylinder assembly 50 to the frame 42, and a bracket 62 for mounting a proximity switch 66. The frame 42 is securely fastened to a wall of the pit 38 to support the hold-down cylinder assembly 46 and the hook cylinder assembly 50.

The hold-down cylinder assembly 46 includes a hold-down cylinder 70 and a plunger rod 78 extending therefrom. The end of the plunger rod 78 includes an eyelet 82, which couples the hold-down cylinder assembly 46 to the hook cylinder assembly 50. The hold-down cylinder 70 is provided with two trunnions 86 that are received within the first set of cylinder keepers 54, and a hose port 90 for connecting the hold-down cylinder 70 to the hydraulic power unit. The hold-down cylinder assembly 46 also includes a piston 92 connected to the rod 78. The piston 92 separates the hold-down cylinder 70 into a stem side containing the rod 78 and an opposite open side. A compression spring 93 is located on the stem side within the hold-down cylinder 70.

The hook cylinder assembly 50 includes a hook cylinder 94 and a plunger rod 102 extending therefrom. The hook cylinder 94 is provided with two trunnions 106 that are placed in the second set of cylinder keepers 58, a sensing target 108 connected to one of the trunnions 106 for operation with the proximity switch 66, and two hose ports 110 (only one shown) for connecting the hook cylinder 94 to the hydraulic power unit. The hook cylinder assembly 50 also includes a hook member 114 coupled to the plunger rod 102, a set of plate members 118, a track 126 longitudinally mounted to the hook cylinder 94, and a guide rod 130 coupled to the hook member 114 and extending from the track 126. The guide rod 130 provides additional support to the hook member 114 as the plunger rod 102 moves in and out of the cylinder 94. The plate members 118 are coupled to the cylinder 94 to provide a mounting location for a pin 122 that extends through the eyelet 82 to couple the hold-down cylinder assembly 46 to the hook cylinder assembly 50. The hook member 114 includes a generally longitudinally extending portion 134, a restraining portion 138 that is substantially perpendicular to the longitudinal portion 134, and a tab 142 that is substantially perpendicular to the retaining portion 138 and substantially parallel to the longitudinal portion 134.

When not in operation, the vehicle restraint 18 is kept in a stored position as illustrated in FIGS. 1 and 2. The vehicle restraint 19 is designed so the weight of the hook cylinder assembly 50 keeps the trunnions 86 biased against the first set of cylinder keepers 54.

Referring to FIG. 3, once the vehicle 34 is in position adjacent the loading dock 10 and the dock leveler 14 is bridging the gap between the loading dock 10 and the vehicle 34, an operator controls the hydraulic power delivered from the hydraulic power unit to the hold-down cylinder 70 and the hook cylinder 94. The hydraulic power unit is commonly mounted on the floor of the pit 22. Hydraulic power is delivered to the hold-down cylinder 70 and the hook cylinder 94 via hoses or lines (not shown) extending from a manifold of the hydraulic power unit to the hose ports 90 and 110, respectively. The manifold provides hydraulic power to the respective hoses based on the operator inputs.

During operation, the vehicle restraint 18 moves from the stored position to a lowered and retracted position by provision of hydraulic power to extend the plunger rod 78 of the hold-down cylinder assembly 46 until the sensing target 108 contacts the proximity switch 66 (see position of sensing target 108 with respect to proximity switch 66 in FIG. 3). Once in the lowered and retracted position, the hydraulic pressure level of the hold-down cylinder 70 is maintained as hydraulic power is provided to extend the plunger rod 78 of the hook cylinder assembly 50 past the face of the loading dock 10 to a lowered and extended position.

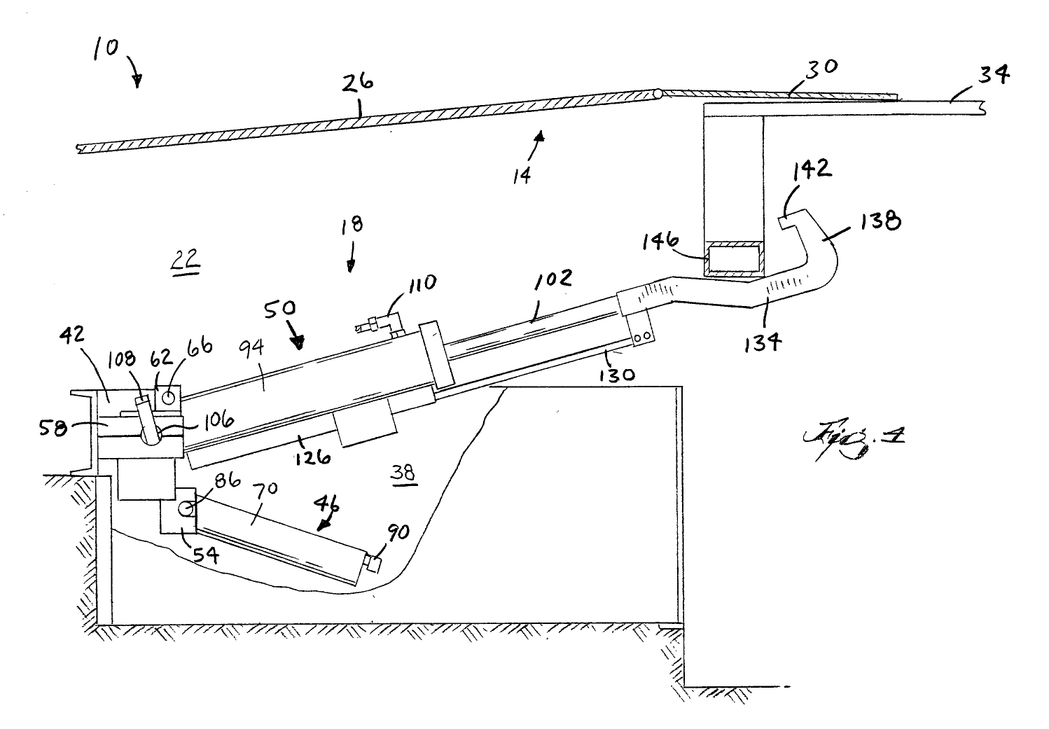

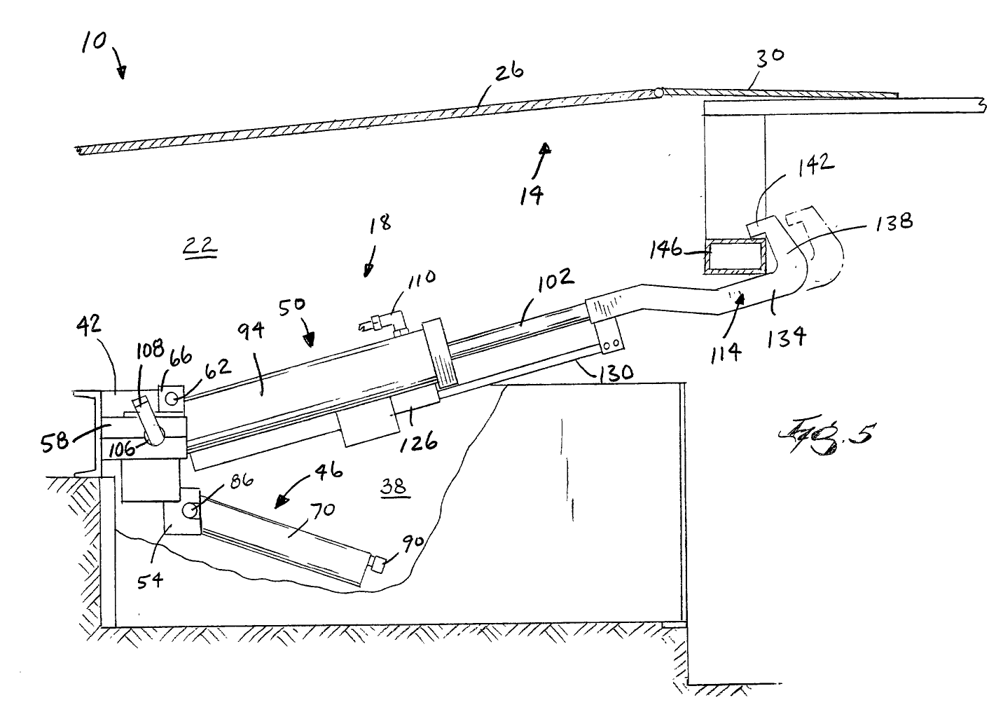

Referring to FIG. 4, while maintaining the hydraulic pressure level of the hook cylinder 94, the plunger rod 78 of the hold-down cylinder 70 retracts, thereby raising the vehicle restraint 18 to a raised and extended position. The plunger rod 102 of the hook cylinder 94 is then retracted to a restrained position, as shown in FIG. 5, where the hook member 114 is secured around three sides of the ICC bar 146 of the vehicle 34.

As shown in FIG. 5, when in the restrained position, the tab 142 extends over the upper portion of the ICC bar 146, the restraining portion 138 contacts the forward portion of the ICC bar 146, and the longitudinal portion 134 extends under the lower portion of the ICC bar 146. Although the spring 93 of the hold-down cylinder assembly 46 allows for vehicle float, the hook member 114 cannot be pried downward due to the tab 142 and the pressure maintained in the hook cylinder 94. In order to manipulate the hook member 114 away from the ICC bar 146, the hook member 114 would need to be moved longitudinally outward away from the loading dock 10 and then downward. The hydraulic pressures of the hook cylinder 94 resist any longitudinal movement of the hook member 114.

A hydraulic pressure sensor is further provided to monitor the hydraulic pressure levels present in the hook cylinder 94. The monitoring can be performed on a continuous or periodic basis. It is common for hydraulic pressure to decrease because of bleeding, vehicle movement, or tampering. When a decreased pressure level is detected, the hydraulic power unit is controlled to provide an increased pressure level to the respective cylinder. Maintenance of the pressure levels ensures that the hook member 114 maintains engagement with the ICC bar 146. Alternative ways of monitoring proper engagement of the hook member 114 with the ICC bar 146 include use of proximity sensors, position switches, strain gages, or any other suitable device.

Guards (not shown) may be provided to protect the hose ports 90 and 110, the hydraulic hoses, and the hydraulic power unit from tampering. In one embodiment, the guards may be constructed of steel and designed to allow for movement of the vehicle restraint 18 as discussed above.

When the vehicle is ready to leave the loading dock, the operator returns the vehicle restraint to the stored position by moving the vehicle restraint 18 in an order opposite to the operation discussed above. Therefore, the vehicle restraint 18 moves from the restrained position to the raised and extended position, to the lowered and extended position, to the lowered and retracted position, and finally to the stored position. The operation described herein represents only one method of operating the vehicle restraint 18, and other methods of operation between the stored and restrained positions are considered to be within the scope of the invention.

The concepts of the present invention can be used to modify existing vehicle restraints in the field. More specifically, the hook member 114 of the present invention could be used to replace hooks that do not have a tab 142 for preventing downward movement of the hook. To facilitate removal of the old hook and replacement with the new hook, the restraint can be moved from the stored position to a lowered and extended position or a raised and extended position. The old hook can then be removed and replaced with the new hook having a tab 142. In this manner, the performance of a vehicle restraint can be improved without the need to replace the entire vehicle restraint.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiments described herein are further intended to explain best modes known for practicing the invention and to enable others skilled in the art to utilize the invention in such, or other, embodiments and with various modifications required by the particular applications or uses of the present invention.

What is claimed is:

1. A vehicle restraint mounted to a loading dock having a dock face, the restraint comprising a hook member adapted to be coupled to the loading dock, the hook member being mounted for movement toward and away from the dock face and further being mounted for movement up and down relative to the dock face, the hook member being arranged such that it will secure three sides of an ICC bar of a vehicle parked at the loading dock.

2. The vehicle restraint of claim 1, wherein the hook member includes a longitudinal portion, a restraining portion, and a tab, and wherein the longitudinal portion is adapted to engage a lower portion of the ICC bar, the restraining portion is adapted to engage a front portion of the ICC bar, and the tab is adapted to engage an upper portion of the ICC bar.

3. The vehicle restraint of claim 1, further comprising a longitudinal actuator for proving movement of the hook member toward and away from the dock face.

4. The vehicle restraint of claim 3, wherein the longitudinal actuator comprises a hydraulic cylinder.

5. The vehicle restraint of claim 3, wherein the longitudinal actuator is pivotal relative to the dock face.

6. The vehicle restraint of claim 1, further comprising a vertical actuator for proving up and down movement of the hook member relative to the dock face.

7. The vehicle restraint of claim 6, wherein the vertical actuator comprises a hydraulic cylinder.

8. A method of securing a vehicle having an ICC bar to a loading dock having a dock face using a vehicle restraint having a hook member, the method comprising:
positioning the vehicle at the loading dock;
moving the hook member upward into alignment with the ICC bar; and
moving the hook member toward the dock face such that the hook member secures at least three sides of the ICC bar to thereby inhibit removal of the hook member from the ICC bar.

9. The method of claim 8, further comprising moving the hook member outward away from the dock face before moving the hook member into alignment with the ICC bar.

10. The method of claim 9, wherein moving the hook member outward comprises extending the hook member from a pit in the dock face.

11. The method of claim 8, wherein moving the hook member upward comprises moving the hook member along a curved path.

12. The method of claim 8, wherein moving the hook member upward comprises positioning a longitudinal portion of the hook member below a lower portion of the ICC bar.

13. The method of claim 8, wherein moving the hook member toward the dock face comprises positioning a tab of the hook member above an upper portion of the ICC bar.

14. The method of claim 8, wherein moving the hook member toward the dock face comprises contacting a restraining portion of the hook member with a front portion of the ICC bar.

15. The method of claim 8, further comprising:
monitoring the position of the hook member; and
moving the hook member toward the dock face in the event that sufficient engagement is not maintained between the hook member and the ICC bar.

16. The method of claim 15, wherein moving the hook member toward the dock face comprises actuating a hydraulic cylinder, and wherein monitoring comprises sensing a pressure of hydraulic fluid.
